(19) United States
(12) Patent Application Publication
(10) Pub. No.: US 2021/0328413 A1
(43) Pub. Date: Oct. 21, 2021

(54) BUS SECTION OF A CURRENT CARRYING BUS ITSELF CONFIGURED AS A HEAT SINK IN AN ELECTRICAL SYSTEM

(71) Applicant: Siemens Industry, Inc., Alpharetta, GA (US)

(72) Inventors: Sibi Mathew, Edgecliff Village, TX (US); Donald Carey Boston, Arlington, TX (US)

(21) Appl. No.: 16/853,788

(22) Filed: Apr. 21, 2020

(51) Int. Cl. H02B 1/20; H02B 1/56

(52) U.S. Cl. CPC H02B 1/20; H02B 1/56

(57) ABSTRACT

An electrical system comprises a first structure, an element or a bus of an electrical structure that conducts electricity and configured to flow electric current therethrough. The electrical system further comprises an extended second structure that extends past an adjoining section of the electrical structure with current flow and that acts as a heat sink not in line with a path of current flow such that the heat sink allows for heat to move through the heat sink but with no current flow through the heat sink because there is no voltage gradient in the extended second structure. The heat sink is a bus section of the bus such that both of them are in a one-piece form.

### BACKGROUND

### 1. Field

Aspects of the present invention generally relate to a bus section of a current carrying bus itself configured as a heat sink in an electrical system.

### 2. Description of the Related Art

Switchgear and switchboard are general terms which cover metal enclosures housing switching and interrupting devices such as fuses and circuit breakers along with associated control, instrumentation and metering devices. Switchgear and switchboard also house assemblies of these devices with associated buses, interconnections and supporting structures used for distribution of electric power.

Electrical rooms are getting consistently smaller—it is necessary to consider designs that have smaller footprints in order to drive more design preferences. A new product being a main section with an insulated case circuit breaker is in a 25″ W section and allows for currents up to 3000 A. Because of the narrow section, there is less ventilation and hence it is more difficult to pass industry required heat tests. Under these conditions, the bus will tend to be at higher than acceptable temperatures. In order to pass the required temperature tests, the temperature of the bus had to be reduced.

Industries use separate add on heat sinks to reduce bus temperature. The add on piece is time consuming because of the time required to install a heat sink and cost prohibitive because usual add on heat sinks have intricate design that are molded or cast pieces or they are made of expensive electrically insulative thermally conductive materials.

Therefore, there is a need for a heat sink design that can be readily used in electrical devices or electrical apparatus.

### SUMMARY

Briefly described, aspects of the present invention relate to a heat sink design that can be used in electrical devices or electrical apparatus. While the invention was made on the 25″ W 3000 A WL main section platform, the invention (heat sink design) is not limited to a particular frame width or amperage or type of electrical system. Producing a cost effect design that meets industry requirements required incorporating new features into the design that allowed for successful passing industry heat tests. In order to produce a main section design in the narrow 25″ W section, a cost-effective bus design was developed that allowed for the bus to run at lower temperatures than it would otherwise. The bus in this design acts as both a conductive member within an electrical system such as a switchboard as well as a heat sink. There are no separate add-on heat sinks. The path of the current in these heat sinks or parts is between adjoining pieces of bus material, in this case from the middle of the bus to the other end of the bus. This is key because there is a portion of bus with no current flow and that allows for a lower temperature bus. Portions of the bus that extend away from the connection (and in which there is no current flow) is exposed to ambient air on both sides of each part. The new design can be applied to individual members or in a lamination sub assembly.

In accordance with one illustrative embodiment of the present invention, a switchboard is provided. It comprises a main section having a three-phase bus structure. The three-phase bus structure includes an upper level through bus with an upper level through bus phase A and a lower level through bus with a lower level through bus phase A. The switchboard further comprises a top horizontal bus with a first bus section connecting a first bus portion with a first extended bus portion and the upper level through bus phase A. The first extended bus portion is positioned beyond a first connection joint between the first bus section and the first bus portion. The first extended bus portion acts as a first heat sink not in line with a path of current flow such that the first heat sink allows for heat to move through the first heat sink but with no current flow through the first heat sink because there is no voltage gradient in the first extended bus portion of the three-phase bus structure that extends past a first adjoining section of the three-phase bus structure with current flow. The switchboard further comprises a bottom horizontal bus with a second bus section connecting a second bus portion with a second extended bus portion and the lower level through bus phase A. The second extended bus portion is positioned beyond a second connection joint between the second bus section and the second bus portion.

In accordance with one illustrative embodiment of the present invention, a switchboard is provided. It comprises an electrical system having a three-phase bus structure. The three-phase bus structure includes an upper level through bus with an upper level through bus phase A and a lower level through bus with a lower level through bus phase A. The switchboard further comprises a top vertical bus with a first bus section connecting a first bus portion with a first extended bus portion and the upper level through bus phase A. The first extended bus portion is positioned beyond a first connection joint between the first bus section and the first bus portion. The first extended bus portion acts as a first heat sink not in line with a path of current flow such that the first heat sink allows for heat to move through the first heat sink but with no current flow through the first heat sink because there is no voltage gradient in the first extended bus portion of the three-phase bus structure that extends past a first adjoining section of the three-phase bus structure with current flow. The switchboard further comprises a bottom vertical bus with a second bus section connecting a second bus portion with a second extended bus portion and the lower level through bus phase A. The second extended bus portion is positioned beyond a second connection joint between the second bus section and the second bus portion.

In accordance with one illustrative embodiment of the present invention, an electrical system comprises a first structure, an element or a bus of an electrical structure that conducts electricity and configured to flow electric current therethrough. The electrical system further comprises an extended second structure that extends past an adjoining section of the electrical structure with current flow and that acts as a heat sink not in line with a path of current flow such that the heat sink allows for heat to move through the heat sink but with no current flow through the heat sink because there is no voltage gradient in the extended second structure. The heat sink is a bus section of the bus such that both of them are in a one-piece form.

### BRIEF DESCRIPTION OF THE DRAWINGS

FIG. 1 illustrates a perspective view of a switchboard comprising a main section having a three-phase bus structure with a bus section of a current carrying bus itself configured as a heat sink in accordance with an exemplary embodiment of the present invention.

FIG. 2 illustrates a perspective view of the switchboard of FIG. 1 with all the PHASE A bus sections shown in accordance with an exemplary embodiment of the present invention.

FIG. 3 illustrates internal current pathways in the switchboard of FIG. 1 in accordance with an exemplary embodiment of the present invention.

FIG. 4 illustrates a front view of the switchboard of FIG. 1 in accordance with an exemplary embodiment of the present invention.

FIG. 5 illustrates a top view of the switchboard of FIG. 1 in accordance with an exemplary embodiment of the present invention.

FIG. 6 illustrates an isometric view of a middle section of the switchboard of FIG. 1 in accordance with an exemplary embodiment of the present invention.

FIG. 7 illustrates a side view of the middle section of the switchboard of FIG. 6 in accordance with an exemplary embodiment of the present invention.

FIG. 8 illustrates an isometric view of a Phase C portion of the middle section of the switchboard of FIG. 1 in accordance with an exemplary embodiment of the present invention.

FIG. 9 illustrates an exploded view of the Phase C portion of the middle section of the switchboard of FIG. 8 in accordance with an exemplary embodiment of the present invention.

FIG. 10 illustrates a view of internal current pathways in the Phase C portion of the middle section of the switchboard of FIG. 8 in accordance with an exemplary embodiment of the present invention.

FIG. 11 illustrates a schematic view of an electrical system with a bus section of a current carrying bus itself configured as a heat sink in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of an electrical system including a bus section of a current carrying bus itself configured as a heat sink. For example, a switchboard comprises a main section having a three-phase bus structure with a bus section of a current carrying bus itself configured as a heat sink. Accordingly, an extended heat sink design is built into a bus structure of an electrical apparatus. There is no separate add on heat sinks. Therefore, the extended heat sink and the bus design is easier to install and doesn't need additional hardware pieces to install. The extended heat sink design facilitates the removal of thermal energy generated in the electrical apparatus bus due to current flow. The extended heat sink acts as a fin with its surface area exposed to ambient air and thereby allows for the bus generated heat to be transferred to the ambient air. The extended heat sink and the bus design is more effective at heat removal because: unlike add on heat sink which have additional inherent thermal contact resistance due to adjoining pieces, these built in heat sinks do not have such contact resistance limiting its ability to remove heat while if additional heat sinks are added in line with the path of current flow, the heat sink itself would see electricity flowing through it and hence be producing additional heat. Therefore, such in line heat sink would be less effective as heat removal mechanisms because they would be both removing heat as well as generating heat. The extended heat sinks are made of conventional electrical apparatus bus material like aluminum and copper. They do not use exotic thermally conductive and electrically insulative materials as heat sinks. This makes new solution more cost effective and more production friendly. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

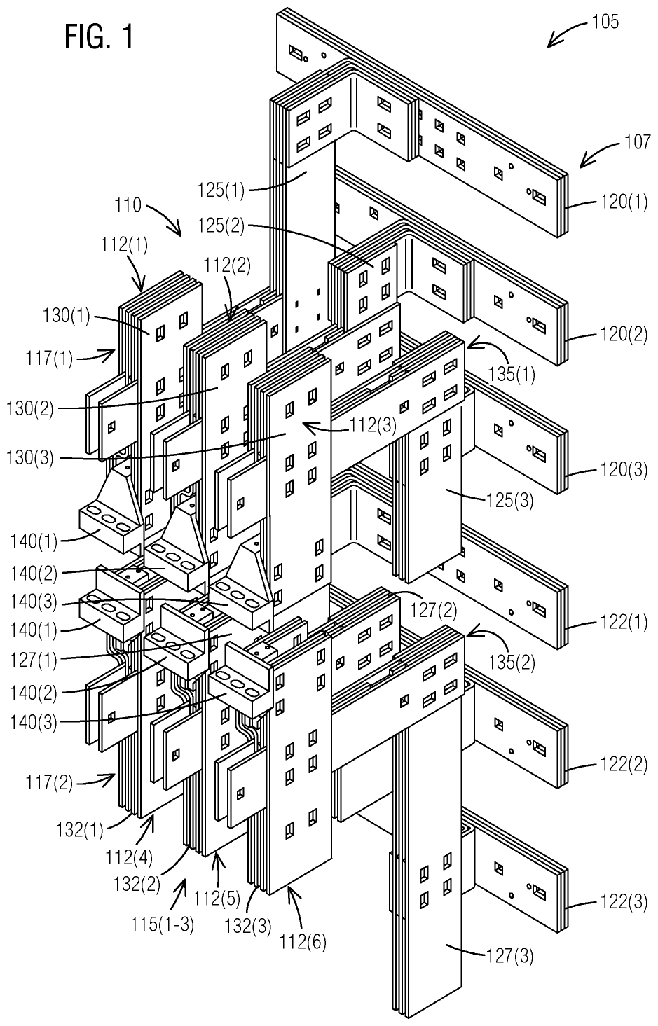

These and other embodiments of extended heat sinks as bus sections of a current carrying bus itself in an electrical system according to the present disclosure are described below with reference to FIGS. 1-11 herein. Like reference numerals used in the drawings identify similar or identical elements throughout the several views. The drawings are not necessarily drawn to scale.

Consistent with one embodiment of the present invention, FIG. 1 represents a perspective view of a switchboard 105 comprising a main section 107 having a three-phase bus structure 110 with extended bus sections 112(1-6) of a current carrying bus A, B, C 115(1-3) itself configured as a heat sink 117(1-2) in accordance with an exemplary embodiment of the present invention. The three-phase bus structure 110 comprises a through bus phase A, B, C, (upper level) 120(1-3) and a through bus phase A, B, C, (lower level) 122(1-3). The three-phase bus structure 110 further comprises a riser bus through bus side (upper level) 125(1-3) and a riser bus through bus side (lower level) 127(1-3). The riser bus through bus side (upper level) 125 is coupled to the through bus phase A, B, C, (upper level) 120(1-3). The riser bus through bus side (lower level) 127 is coupled to the through bus phase A, B, C, (lower level) 122(1-3). The three-phase bus structure 110 further comprises a breaker connection raiser bus (upper) 130(1-3) and a breaker connection raiser bus (lower) 132(1-3). The breaker connection raiser bus (upper) 130(1-3) is coupled to the through bus phase A, B, C, (upper level) 120(1-3) via a top horizontal bus (upper) 135(1). The breaker connection raiser bus (lower) 132(1-3) is coupled to the through bus phase A, B, C, (lower level) 122(1-3) via a bottom horizontal bus (lower) 135(2). The three-phase bus structure 110 further comprises a breaker connector phase A, B, C 140(1-3).

In one embodiment, a switchboard like the switchboard 105 may comprise an electrical system having a three-phase bus structure. The three-phase bus structure may include an upper level through bus with an upper level through bus phase A and a lower level through bus with a lower level through bus phase A.

The switchboard like the switchboard 105 may comprise a top vertical bus with a first bus section connecting a first bus portion with a first extended bus portion and the upper level through bus phase A. The first extended bus portion may be positioned beyond a first connection joint between the first bus section and the first bus portion. The first extended bus portion acts as a first heat sink not in line with a path of current flow such that the first heat sink allows for heat to move through the first heat sink but with no current flow through the first heat sink because there is no voltage gradient in the first extended bus portion of the three-phase bus structure that extends past a first adjoining section of the three-phase bus structure with current flow. The switchboard like the switchboard 105 may comprise a bottom vertical bus with a second bus section connecting a second bus portion with a second extended bus portion and the lower level through bus phase A. The second extended bus portion may be positioned beyond a second connection joint between the second bus section and the second bus portion. The second extended bus portion acts as a second heat sink not in line with a path of current flow such that the second heat sink allows for heat to move through the second heat sink but with no current flow through the second heat sink because there is no voltage gradient in the second extended bus portion of the three-phase bus structure that extends past a second adjoining section of the three-phase bus structure with current flow.

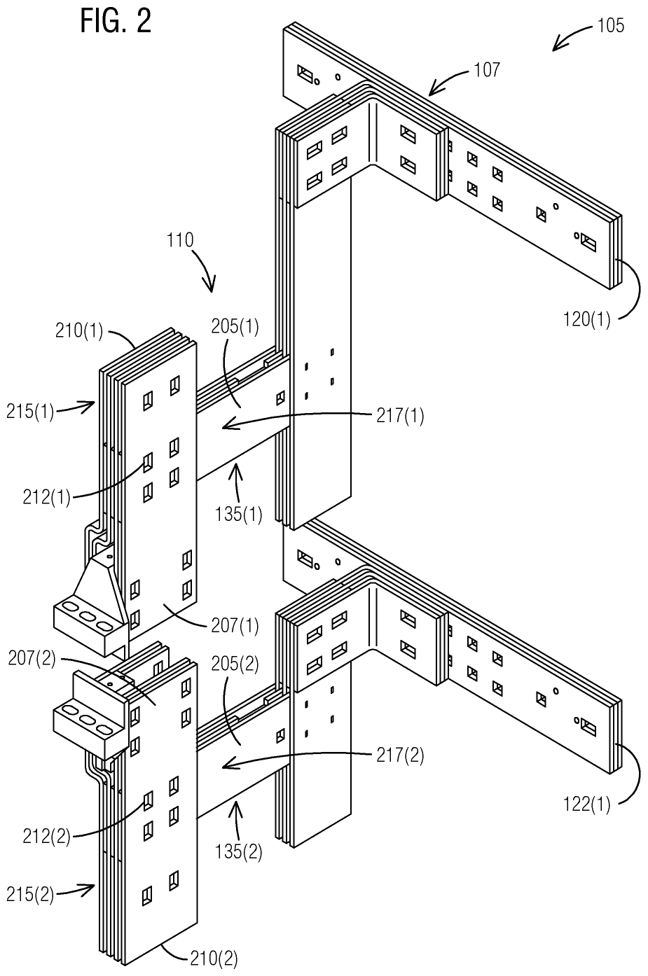

Referring to FIG. 2, it illustrates a perspective view of the switchboard 105 of FIG. 1 with all the PHASE A bus sections shown in accordance with an exemplary embodiment of the present invention. The switchboard 105 comprises the main section 107 having the three-phase bus structure 110. The three-phase bus structure 110 includes the upper level through bus 120(1-3) with an upper level through bus phase A 120(1). The three-phase bus structure 110 further includes the lower level through bus 122(1-3) with a lower level through bus phase A 122(1).

The three-phase bus structure 110 further includes the top horizontal bus 135(1) with a first bus section 205(1) connecting a first bus portion 207(1) with a first extended bus portion 210(1) and the upper level through bus phase A 120(1). The first extended bus portion 210(1) is positioned beyond a first connection joint 212(1) between the first bus section 205(1) and the first bus portion 207(1). The first extended bus portion 210(1) acts as a first heat sink 215(1) not in line with a path of current flow such that the first heat sink 215(1) allows for heat to move through the first heat sink 215(1) but with no current flow through the first heat sink 215(1) because there is no voltage gradient in the first extended bus portion 210(1) of the three-phase bus structure 110 that extends past a first adjoining section 217(1) of the three-phase bus structure 110 with current flow. The three-phase bus structure 110 further includes the bottom horizontal bus 135(2) with a second bus section 205(2) connecting a second bus portion 207(2) with a second extended bus portion 210(2) and the lower level through bus phase A 122(1). The second extended bus portion 210(2) is positioned beyond a second connection joint 212(2) between the second bus section 205(2) and the second bus portion 207(2).

The second extended bus portion 210(2) acts as a second heat sink 215(2) not in line with a path of current flow such that the second heat sink 215(2) allows for heat to move through the second heat sink 215(2) but with no current flow through the second heat sink 215(2) because there is no voltage gradient in the second extended bus portion 210(2) of the three-phase bus structure 110 that extends past a second adjoining section 217(2) of the three-phase bus structure 110 with current flow.

The first heat sink 215(1) is configured as a first fin with its surface area exposed to an ambient air and thereby allowing for bus generated heat to be transferred to the ambient air. The second heat sink 215(2) is configured as a second fin with its surface area exposed to an ambient air and thereby allowing for bus generated heat to be transferred to the ambient air.

The three-phase bus structure 110 includes the upper level through bus 120(1-3) with an upper level through bus phase B 120(2) and the lower level through bus 122(1-3) with a lower level through bus phase B 122(2). Like the case of phase A described above, the top horizontal bus 135(1) includes a third bus section connecting a third bus portion with a third extended bus portion and the upper level through bus phase B. The third extended bus portion is positioned beyond a third connection joint between the third bus section and the third bus portion. The third extended bus portion acts as a third heat sink not in line with a path of current flow such that the third heat sink allows for heat to move through the third heat sink but with no current flow through the third heat sink because there is no voltage gradient in the third extended bus portion of the three-phase bus structure that extends past a third adjoining section of the three-phase bus structure with current flow. Like the case of phase A described above, the bottom horizontal bus 135(2) includes a fourth bus section connecting a fourth bus portion with a fourth extended bus portion and the lower level through bus phase B. The fourth extended bus portion is positioned beyond a fourth connection joint between the fourth bus section and the fourth bus portion.

The three-phase bus structure 110 includes the upper level through bus 120(1-3) with an upper level through bus phase C 120(3) and the lower level through bus 122(1-3) with a lower level through bus phase C 122(3). Like the case of phase A described above, the top horizontal bus 135(1) includes a fifth section connecting a fifth bus portion with a fifth extended bus portion and the upper level through bus phase C. The fifth extended bus portion is positioned beyond a fifth connection joint between the fifth bus section and the fifth bus portion. The fifth extended bus portion acts as a fifth heat sink not in line with a path of current flow such that the fifth heat sink allows for heat to move through the fifth heat sink but with no current flow through the fifth heat sink because there is no voltage gradient in the fifth extended bus portion of the three-phase bus structure that extends past a fifth adjoining section of the three-phase bus structure with current flow. Like the case of phase A described above, the bottom horizontal bus 135(2) includes a sixth bus section connecting a sixth bus portion with a sixth extended bus portion and the lower level through bus phase C. The sixth extended bus portion is positioned beyond a sixth connection joint between the sixth bus section and the sixth bus portion.

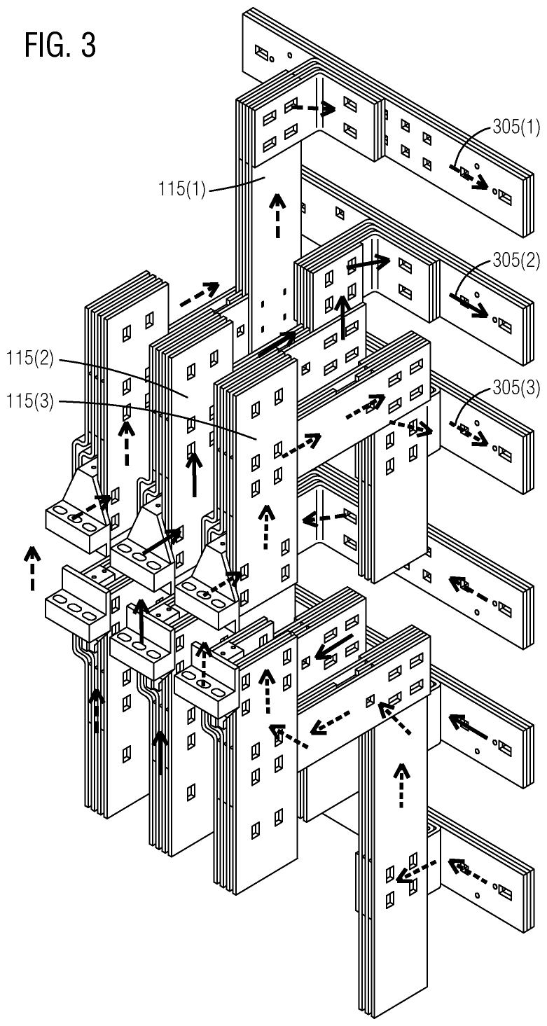

Turning to FIG. 3, it illustrates internal current pathways 305(1-3) in the switchboard 105 of FIG. 1 in accordance with an exemplary embodiment of the present invention. The current pathway 305(1) is in the current carrying bus A 115(1), the current pathway 305(2) is in the current carrying bus B 115(2) and the current pathway 305(3) is in the current carrying bus C 115(3). The path of the current in these heat sinks such as the heat sink 117 (shown in FIG. 1) is between adjoining pieces of bus material, in this case from the middle (e.g., 207(1)) of the current carrying bus A, B, C 115(1-3) to the other end (e.g., 120(1)) of the current carrying bus A, B, C 115(1-3). This is key because there is a portion of the current carrying bus A, B, C 115(1-3) with no current flow and that allows for a lower temperature bus. Portions such as the extended bus sections 112(1-3) (seen in FIG. 1) of the current carrying bus A, B, C 115(1-3) that extend away from a connection (and in which there is no current flow) is exposed to ambient air on both sides of each part.

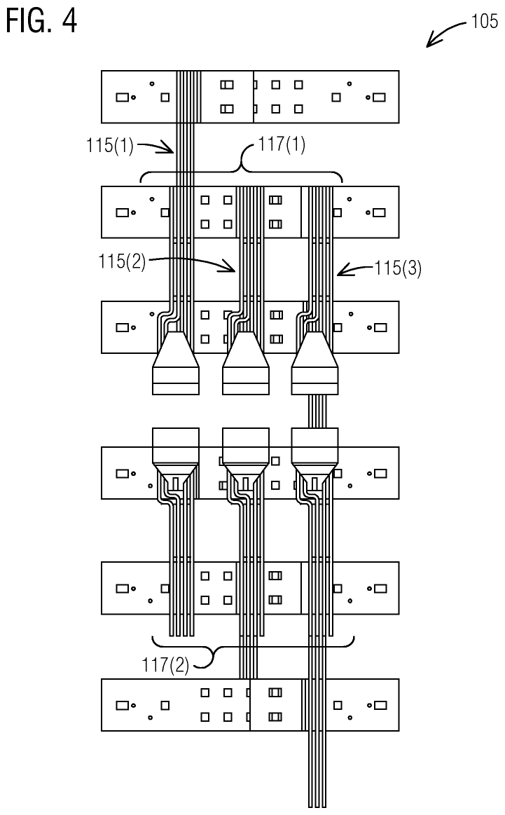

FIG. 4 illustrates a front view of the switchboard 105 of FIG. 1 in accordance with an exemplary embodiment of the present invention. In the switchboard 105, a main section with a breaker may be in a 25″ W section that allows for currents up to 3000 A. For example, for a main section the current carrying bus A, B, C 115(1-3) allows for the bus 115(1-3) to run at lower temperatures than it would otherwise. The bus 115(1-3) in this design acts as both a conductive member within the switchboard 105 as well as the heat sink 117(1-2). There are no separate add-on heat sinks. The path of the current in the heat sink 117(1-2) is between adjoining pieces of bus material, in this case from the middle (e.g., 207(1)) of the bus 115(1-3) to the other end (e.g., 120(1)) of the bus 115(1-3). This is key because there is a portion of the bus 115(1-3) with no current flow and that allows for a lower temperature bus. Portions of the bus 115(1-3) that extend away from the connection (and in which there is no current flow) is exposed to ambient air on both sides of the heat sink 117(1-2).

The heat sink 117(1-2) facilitates the removal of thermal energy generated in an electrical apparatus bus due to current flow. The heat sink 117(1-2) acts as a fin with its surface area exposed to ambient air and thereby allows for the bus 115(1-3) generated heat to be transferred to the ambient air. The heat sink 117(1-2) and the bus 115(1-3) is more effective at heat removal because the built in heat sink 117(1-2) do not have contact resistance limiting its ability to remove heat. The heat sink 117(1-2) is made of conventional electrical apparatus bus material like aluminum and copper. It does not use exotic thermally conductive and electrically insulative materials as heat sinks.

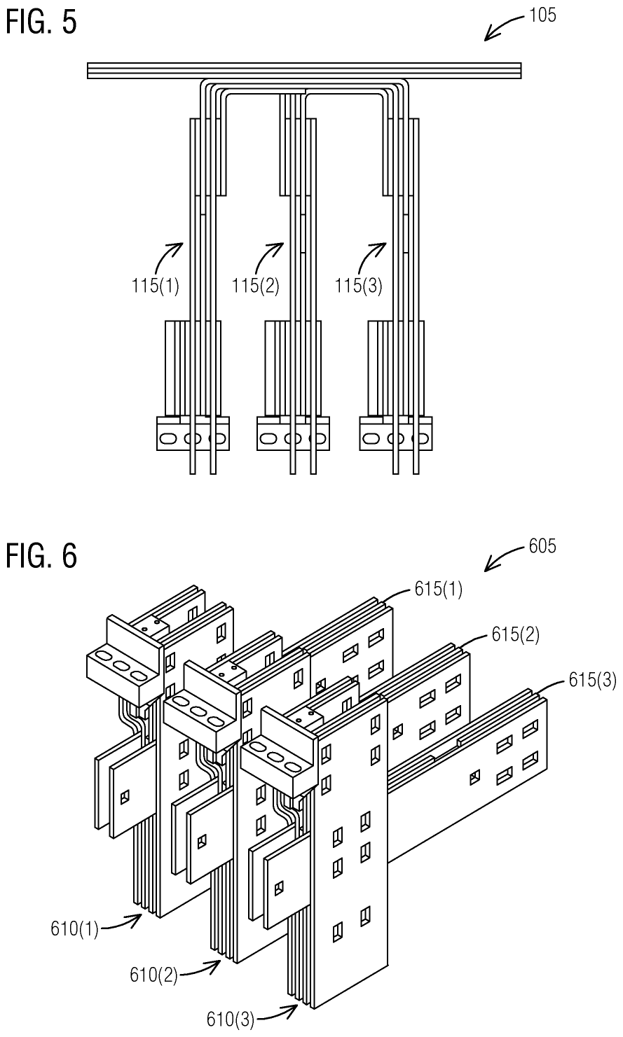

As seen in FIG. 5, it illustrates a top view of the switchboard 105 of FIG. 1 in accordance with an exemplary embodiment of the present invention. With the heat sink 117, the bus 115(1-3) will tend to be at lower and acceptable temperatures. In order to pass the required temperature tests, the temperature of the bus 115(1-3) is reduced by the heat sink 117. The heat sink 117 is a heat sink design that can be readily used in electrical devices or electrical apparatus.

As shown in FIG. 6, it illustrates an isometric view of a middle section 605 of the switchboard 105 of FIG. 1 in accordance with an exemplary embodiment of the present invention. The middle section 605 includes three extended heat sinks 610(1-3). The extended heat sinks 610(1-3) are each a laminated assembly. The extended heat sinks 610(1-3) extend vertically from a horizontal bus 615(1-3).

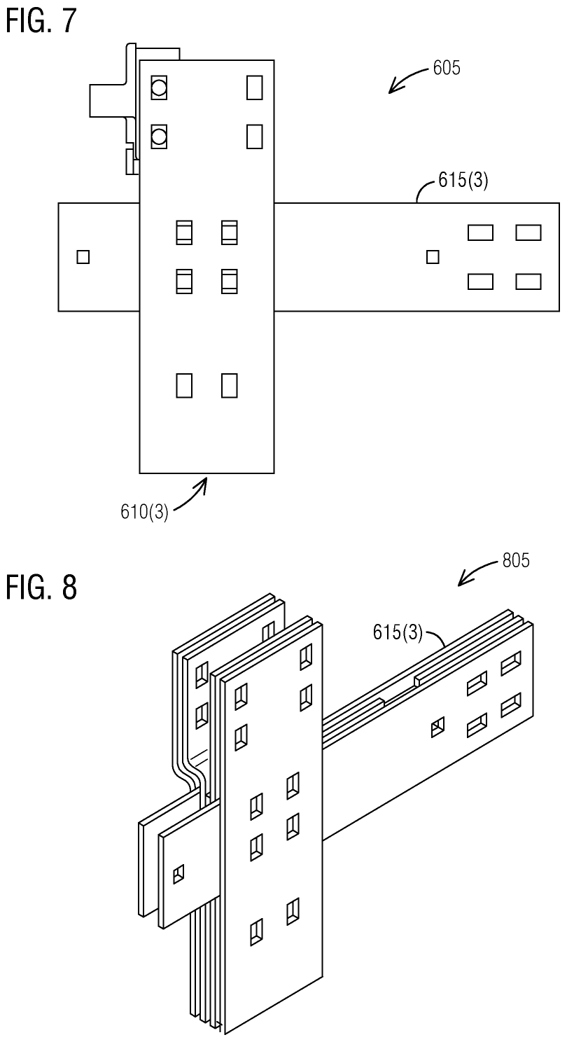

In FIG. 7, it illustrates a side view of the middle section 605 of the switchboard 105 of FIG. 6 in accordance with an exemplary embodiment of the present invention. The extended heat sinks 610(1-3) are built into a bus structure of an electrical apparatus. There is no separate add on heat sinks. Therefore, the extended heat sinks 610(1-3) and the bus design are easier to install and don't need additional hardware pieces to install. Examples of the electrical apparatus include switchgear and switchboard that house assemblies of devices with associated buses, interconnections and supporting structures used for distribution of electric power.

With regard to FIG. 8, it illustrates an isometric view of a Phase C portion 805 of the middle section 605 of the switchboard 105 of FIG. 1 in accordance with an exemplary embodiment of the present invention. The extended heat sink 610(3) is built into a bus structure of the switchboard 105 of FIG. 1. The extended heat sink 610(3) don't need additional hardware pieces to install.

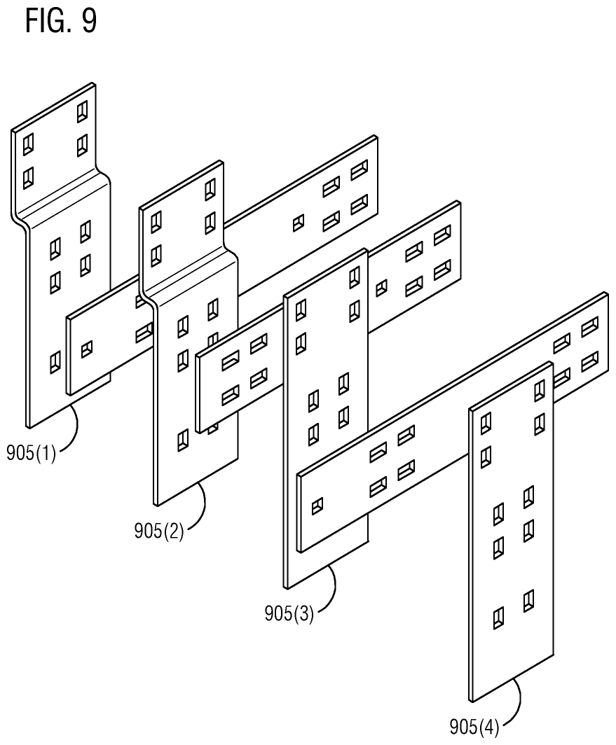

With respect to FIG. 9, it illustrates an exploded view of the Phase C portion 805 of the middle section 605 of the switchboard 105 of FIG. 8 in accordance with an exemplary embodiment of the present invention. The extended heat sink 610(3) comprises conductive laminations 905(1-4) stacked together to form the heat sink. Length and thickness of these conductive laminations 905(1-4) depend upon a specific application such as current rating.

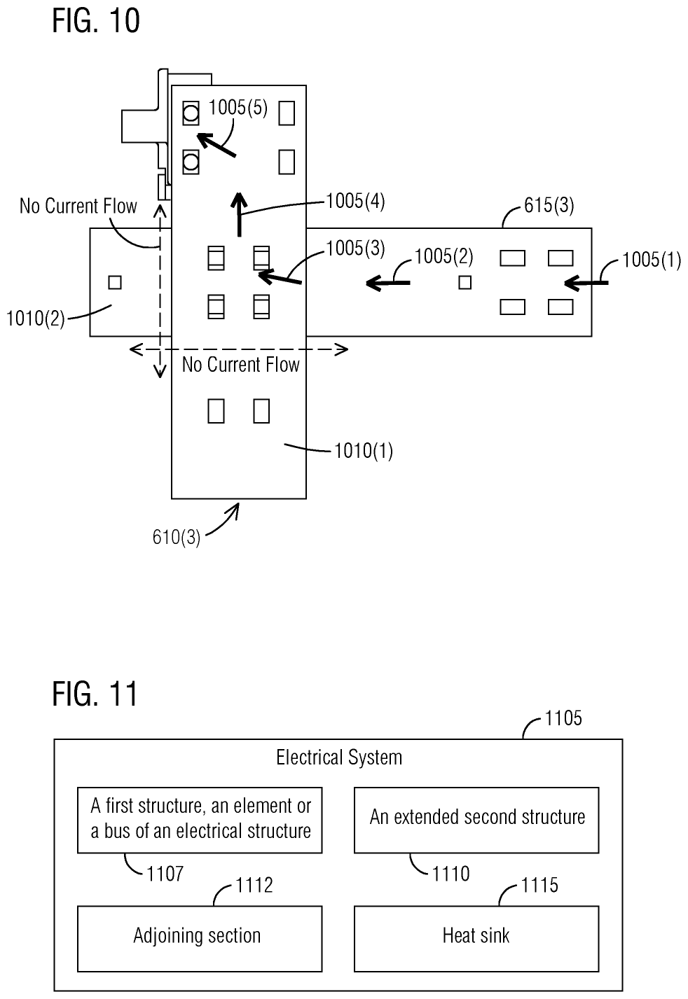

FIG. 10 illustrates a view of internal current pathways 1005(1-5) in the Phase C portion 805 of the middle section 605 of the switchboard 105 of FIG. 8 in accordance with an exemplary embodiment of the present invention. The Phase C portion 805 of the middle section 605 of the switchboard 105 includes first and second no current flow regions 1010(1-2). These first and second no current flow regions 1010(1-2) act as a heat sink since they irradiate thermal energy without ant current flow.

FIG. 11 illustrates a schematic view of an electrical system 1105 with a bus section of a current carrying bus itself configured as a heat sink in accordance with an exemplary embodiment of the present invention. The electrical system 1105 may be a single phase or a three phase. The electrical system 1105 may be a switchboard or a panelboard or a switchgear.

The electrical system 1105 comprises a first structure, an element or a bus of an electrical structure 1107 that conducts electricity and configured to flow electric current therethrough. The bus may be a vertical bus or a horizontal bus.

The electrical system 1105 further comprises an extended second structure 1110 that extends past an adjoining section 1112 of the electrical structure with current flow and that acts as a heat sink 1115 not in line with a path of current flow such that the heat sink 1115 allows for heat to move through the heat sink 1115 but with no current flow through the heat sink 1115 because there is no voltage gradient in the extended second structure 1110. The heat sink 1115 is a bus section of the bus such that both of them are in a one-piece form. The heat sink 1115 has a size and dimensions which depend on a heat load, a size of the electrical system 1105 and dimensional constraints. The heat sink 1115 may be in a vertical orientation or a horizontal orientation.

The first structure, the element or the bus of the electrical structure 1107 is part of an electrically powered device powered via an AC supply or a DC supply or a battery. The electrically powered device includes mobile devices or a power distribution system like residential load centers or DC motors.

The switchboard 105 of FIG. 1 intentionally extends the bus past the adjoining bus pieces. This allows for a single piece heat sink design that allows for heat to move through it but with no current flow through it because there is no voltage gradient in the part of the bus that extends past an adjoining section. In order to be most effective in heat removal, the extended portions of the bus are in the direction of the primary length of the bus. This eliminates the need for additional material processing (additional bends/cuts) in order to conform the bus for electrical apparatus application.

The switchboard 105 of FIG. 1 reduced the bus temperature and hence were able to successfully pass industry required temperature tests for a 3000 A WL main section in the narrow 25″ W frame. This is the smallest footprint in the industry for such a high amperage. This achieves a cost-effective design in a narrower section. Current design is in a 38″ W section and the new design allows for a 25″ W section. This allows for cost savings by using less bus material. It is a cost-effective solution because the heat sinks design is part of the bus and there is no separate add on piece. The switchboard 105 of FIG. 1 does not use expensive thermally conductive electrically insulative materials. While the invention was made on the 25″ W 3000 A WL main section platform, the invention (heat sink design) is not limited to a particular frame width or amperage or type of electrical system.

While a switchboard comprising a main section having a three-phase bus structure is described here a range of one or more other electrical devices or electrical apparatus or other forms of electrical systems are also contemplated by the present invention. For example, other types of electrical systems such as panelboards or switchgears may be implemented based on one or more features presented above without deviating from the spirit of the present invention.

The techniques described herein can be particularly useful for a 25″ W section with a heat sink being part of the bus so that there is no separate add on piece. While particular embodiments are described in terms of a 25″ W section, the techniques described herein are not limited to such a structure but can also be used with other panelboards, switchgears and switchboards.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A switchboard, comprising:
a main section having a three-phase bus structure, wherein the three-phase bus structure including:
an upper level through bus with an upper level through bus phase A;
a lower level through bus with a lower level through bus phase A;
a top horizontal bus with a first bus section connecting a first bus portion with a first extended bus portion and the upper level through bus phase A, wherein the first extended bus portion is positioned beyond a first connection joint between the first bus section and the first bus portion,
wherein the first extended bus portion acts as a first heat sink not in line with a path of current flow such that the first heat sink allows for heat to move through the first heat sink but with no current flow through the first heat sink because there is no voltage gradient in the first extended bus portion of the three-phase bus structure that extends past a first adjoining section of the three-phase bus structure with current flow; and
a bottom horizontal bus with a second bus section connecting a second bus portion with a second extended bus portion and the lower level through bus phase A, wherein the second extended bus portion is positioned beyond a second connection joint between the second bus section and the second bus portion.

2. The switchboard of claim 1, wherein the second extended bus portion acts as a second heat sink not in line with a path of current flow such that the second heat sink allows for heat to move through the second heat sink but with no current flow through the second heat sink because there is no voltage gradient in the second extended bus portion of the three-phase bus structure that extends past a second adjoining section of the three-phase bus structure with current flow.

3. The switchboard of claim 1, wherein the first heat sink is configured as a first fin with its surface area exposed to an ambient air and thereby allowing for bus generated heat to be transferred to the ambient air.

4. The switchboard of claim 1, wherein the second heat sink is configured as a second fin with its surface area exposed to an ambient air and thereby allowing for bus generated heat to be transferred to the ambient air.

5. The switchboard of claim 1, wherein the three-phase bus structure including:
the upper level through bus with an upper level through bus phase B;
the lower level through bus with a lower level through bus phase B;
the top horizontal bus with a third bus section connecting a third bus portion with a third extended bus portion and the upper level through bus phase B, wherein the third extended bus portion is positioned beyond a third connection joint between the third bus section and the third bus portion.

6. The switchboard of claim 5, wherein the third extended bus portion acts as a third heat sink not in line with a path of current flow such that the third heat sink allows for heat to move through the third heat sink but with no current flow through the third heat sink because there is no voltage gradient in the third extended bus portion of the three-phase bus structure that extends past a third adjoining section of the three-phase bus structure with current flow.

7. The switchboard of claim 6, wherein the three-phase bus structure including:
the bottom horizontal bus with a fourth bus section connecting a fourth bus portion with a fourth extended bus portion and the lower level through bus phase B, wherein the fourth extended bus portion is positioned beyond a fourth connection joint between the fourth bus section and the fourth bus portion.

8. The switchboard of claim 5, wherein the three-phase bus structure including:
the upper level through bus with an upper level through bus phase C;
the lower level through bus with a lower level through bus phase C;
the top horizontal bus with a fifth section connecting a fifth bus portion with a fifth extended bus portion and the upper level through bus phase C, wherein the fifth extended bus portion is positioned beyond a fifth connection joint between the fifth bus section and the fifth bus portion.

9. The switchboard of claim 8, wherein the fifth extended bus portion acts as a fifth heat sink not in line with a path of current flow such that the fifth heat sink allows for heat to move through the fifth heat sink but with no current flow through the fifth heat sink because there is no voltage gradient in the fifth extended bus portion of the three-phase bus structure that extends past a fifth adjoining section of the three-phase bus structure with current flow.

10. The switchboard of claim 9, wherein the three-phase bus structure including:
the bottom horizontal bus with a sixth bus section connecting a sixth bus portion with a sixth extended bus portion and the lower level through bus phase C, wherein the sixth extended bus portion is positioned beyond a sixth connection joint between the sixth bus section and the sixth bus portion.

11. A switchboard, comprising:
an electrical system having a three-phase bus structure, wherein the three-phase bus structure including:
an upper level through bus with an upper level through bus phase A;
a lower level through bus with a lower level through bus phase A;
a top vertical bus with a first bus section connecting a first bus portion with a first extended bus portion and the upper level through bus phase A, wherein the first extended bus portion is positioned beyond a first connection joint between the first bus section and the first bus portion,
wherein the first extended bus portion acts as a first heat sink not in line with a path of current flow such that the first heat sink allows for heat to move through the first heat sink but with no current flow through the first heat sink because there is no voltage gradient in the first extended bus portion of the three-phase bus structure that extends past a first adjoining section of the three-phase bus structure with current flow; and
a bottom vertical bus with a second bus section connecting a second bus portion with a second extended bus portion and the lower level through bus phase A, wherein the second extended bus portion is positioned beyond a second connection joint between the second bus section and the second bus portion.

12. The switchboard of claim 11, wherein the second extended bus portion acts as a second heat sink not in line with a path of current flow such that the second heat sink allows for heat to move through the second heat sink but with no current flow through the second heat sink because there is no voltage gradient in the second extended bus portion of the three-phase bus structure that extends past a second adjoining section of the three-phase bus structure with current flow.

13. An electrical system, comprising:
a first structure, an element or a bus of an electrical structure that conducts electricity and configured to flow electric current therethrough; and
an extended second structure that extends past an adjoining section of the electrical structure with current flow and that acts as a heat sink not in line with a path of current flow such that the heat sink allows for heat to move through the heat sink but with no current flow through the heat sink because there is no voltage gradient in the extended second structure, wherein the heat sink is a bus section of the bus such that both of them are in a one-piece form.

14. The electrical system of claim 13, wherein the electrical system is a switchboard or a panelboard or a switchgear.

15. The electrical system of claim 13, wherein the first structure, the element or the bus of the electrical structure is part of an electrically powered device powered via an AC supply or a DC supply or a battery.

16. The electrical system of claim 13, wherein the electrically powered device includes mobile devices or a power distribution system like residential load centers or DC motors.

17. The electrical system of claim 13, wherein the electrical system is a single phase or a three phase.

18. The electrical system of claim 13, wherein the heat sink having a size and dimensions which depend on a heat load, a size of the electrical system and dimensional constraints.

19. The electrical system of claim 13, wherein the bus is a vertical bus or a horizontal bus.

20. The electrical system of claim 13, wherein the heat sink is in a vertical orientation or a horizontal orientation.
